(19) United States
(12) Patent Application Publication
(10) Pub. No.: US 2006/0129574 A1
(43) Pub. Date: Jun. 15, 2006

(54) Intergrated modeling method for authoring/modification of illustrated drawing using 3D model and computer-aided design log database

(75) Inventors: Kyung-Su Shin, Daejeon (KR); Cheon-Young Kim, Cheongju (KR); Seong-Hwan Oh, Daejeon (KR); Yeon-Yong Yoo, Daejeon (KR)

Correspondence Address: OSTROLENK FABER GERB & SOFFEN, 1180 AVENUE OF THE AMERICAS, NEW YORK, NY, 100368403, US

(73) Assignee: Agency for Defense Development

(21) Appl. No.: 11/204,075

(22) Filed: Aug. 15, 2005

(30) Foreign Application Priority Data
Dec. 10, 2004 (KR) 1020040104381

(51) Int. Cl. G06F 7/00

(52) U.S. Cl. 707/100

(57) ABSTRACT

An integrated modeling method for Illustrated Drawing (ID) authoring/modification using 3D model and Computer-Aided Design (CAD) Log database, comprising: a first step of performing a 3D Model Import process on the basis of 3D model data and logistics support data saved in each database, converting the imported 3D model file into a file which can be processed in an integrated ID environment, generating meta data from the converted file and then saving the generated meta data; a second step of importing 3D models on the basis of a request list in which Illustrated Drawing authoring is requested in a Technical Manual (TM) authoring system; a third step of adjusting movement, conversion and angle of the 3D model corresponding to a new model file in order to set up a viewing point on the basis of the 3D model if the new model file exists among the 3D models in the second step, and optimally adjusting intervals between parts of the 3D model corresponding to the new model file and automatically exploding the parts of the 3D model corresponding to the new model file in order to efficiently author supply Illustrated Drawing and an exploded view; a fourth step of collectively modifying and revising 3D and 2D ID by checking 3D and 2D modification Log and CAD-Log database corresponding to the existing model file in accordance with a CAD-Log modification procedure if the existing model file exists among the 3D model files in the second step; and a fifth step of performing a 3D/2D data Save/Return process if 2D authoring ID work is completed by performing processes of 2D ID Line Retouch/Edit, 2D ID Group Setup, 2D ID Center Line Setup and 2D ID Hotspot Setup and allowing the ID to be used in all Technical manuals by transmitting acquired paper Technical Manual and Interactive Electronic Technical Manual (IETM) to the paper TM and IETM database.

### BACKGROUND OF THE INVENTION

1. Field of the Invention

The present invention relates to a technique for implementing an automated and integrated Illustrated Drawing authoring environment using Computer Aided Design (CAD) Log and database information, and more particularly, to an integrated modeling method for authoring and modification of Illustrated Drawing used for both a paper technical manual (TM) that meets military specifications and a Class IV Interactive Electronic Technical Manual (IETM) by using 3D model, CAD Log and Logistics Support Analysis (LSA) database based on MIL-STD-1388-2B.

2. Description of the Background Art

In a method for authoring Illustrated Drawing used for a paper technical manual (TM) and an Interactive Electronic Technical Manual (IETM) in accordance with a related art, many men and much time are required because much manual labor or reorganization is needed according to a type of technical manual. In addition, a variety of software tools are being used for diversity, quality improvement and productivity improvement of Illustrated Drawing (ID). There has not been an integrated ID method used to author ID necessary for both the paper TM and the IETM but there have been ID authoring methods specialized by respective companies and fields.

The ID authoring method in accordance with a related art requires many men and much time because much manual labor or reorganization is inputted according to a type of TM.

In addition, since there is no integrated method for authoring the ID necessary to author the paper TM and the IETM, there have been difficulties in authoring the paper TM and the IETM in which the ID and contents of the TM are integrated.

### SUMMARY OF THE INVENTION

Therefore, an object of the present invention is to provide an integrated modeling method for Illustrated Drawing (ID) authoring/modification by simplifying complicated ID used for a paper technical manual (TM) and an Interactive Electronic Technical Manual (IETM) by integrating a 3D ID authoring environment and a 2D ID authoring environment.

Another object of the present invention is to provide an integrated modeling method for ID authoring/modification which is capable of implementing optimized integrated ID authoring environments by integrating Logistic Support Analysis (LSA), paper TM and IETM authoring.

Another objective of the present invention is to provide an integrated modeling method for ID authoring/modification which can automatically revise and modify ID which requires modification by using CAD Log database information when contents of LSA and paper TM/IETM are revised and therefore the revision of the ID is performed automatically.

To achieve these and other advantages and in accordance with the purpose of the present invention, as embodied and broadly described herein, there is provided an integrated modeling method for Illustrated Drawing (ID) authoring/modification using 3D model and Computer-Aided Design (CAD) Log database, comprising a first step of performing a 3D Model Import process on the basis of 3D model data and logistics support data saved in each database, converting the imported 3D model file into a file which can be processed in an integrated ID environment, generating meta data from the converted file and then saving the generated meta data; a second step of importing 3D models on the basis of a request list in which Illustrated Drawing authoring is requested in a Technical Manual (TM) authoring system; a third step of adjusting movement, conversion of the 3D model corresponding to a new model file in order to set up a viewing point on the basis of the 3D model if the new model file exists among the 3D models in the second step, and optimally adjusting intervals between parts of the 3D model corresponding to the new model file and automatically exploding the parts of the 3D model corresponding to the new model file in order to efficiently author Illustrated Drawing of Illustrated Part Breakdown and an exploded view; a fourth step of collectively modifying and revising 3D and 2D ID by checking 3D and 2D modification Log and CAD-Log database corresponding to the existing model file in accordance with a CAD-Log modification procedure if the existing model file exists among the 3D model files in the second step; and a fifth step of performing a 3D/2D data Save/Return process if 2D authoring ID work is completed by performing processes of 2D ID Line Retouch/Edit, 2D ID Group Setup, 2D ID Center Line Setup and 2D ID Hotspot Setup and allowing the ID to be used in all Technical manuals by transmitting acquired paper Technical Manual and Interactive Electronic Technical Manual (IETM) to the paper TM and IETM database.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating an integrated Illustrating Drawing (ID) authoring system in accordance with the present invention;

FIG. 2 is a flowchart illustrating an integrated modeling processing method for ID authoring/modification using 3D model and CAD Log database in accordance with the present invention;

FIG. 3 is a flowchart of a 3D Model Import processing method in accordance with the present invention;

FIG. 4 is a flowchart of a 3D Model Open processing method in accordance with the present invention;

FIG. 5 is a flowchart of a CAD Log processing method in accordance with the present invention;

FIG. 6 is a flowchart of a 3D Viewing Point Setup processing method in accordance with the present invention;

FIG. 7 is a flowchart of a 3D Model Explode processing method in accordance with the present invention;

FIG. 8 is an overall flowchart of an Automatic 2D Extraction processing method accordance with the present invention;

FIG. 9 is a detailed flowchart of a Contour Extraction processing method accordance with the present invention;

FIG. 10 is a flowchart of a Hidden Line Removal processing method accordance with the present invention;

FIG. 11 is a flowchart of a Retouch/Edit processing method in accordance with the present invention;

FIG. 12 is a flowchart of a 2D ID Group Setup processing method;

FIG. 13 is a flowchart of a 2D ID Center Line Setup processing method accordance with the present invention; and

FIG. 14 is a flowchart of a 2D ID Hotspot Setup processing method in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

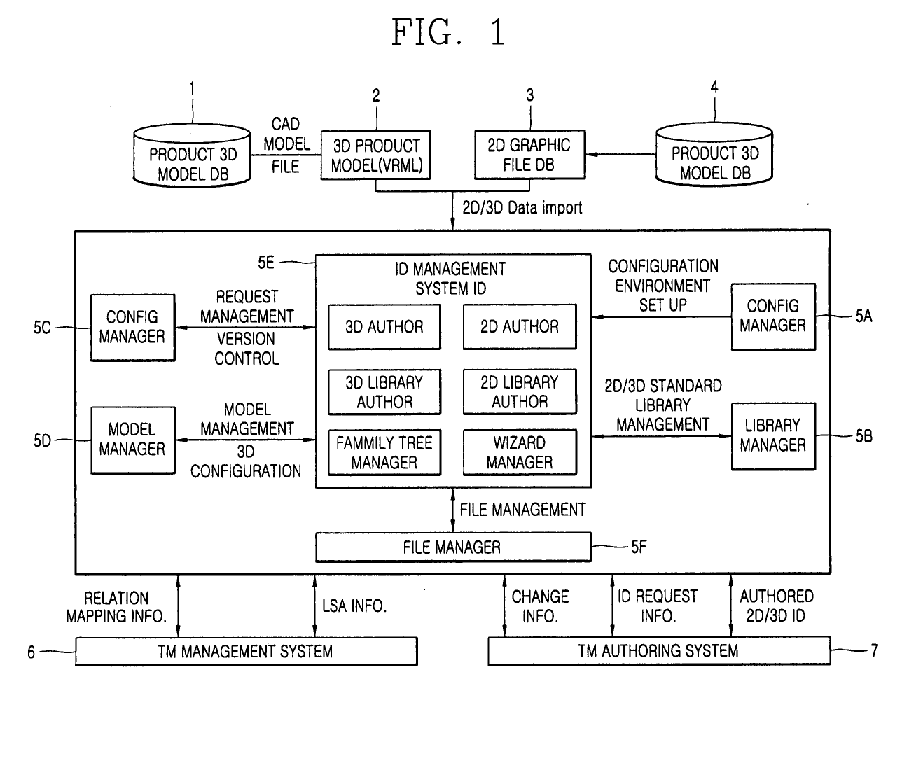

Hereinafter, the preferred embodiments of an integrated modeling method for authoring and modification of Illustrated Drawing (ID) in accordance with the present invention will be described in detail with reference to FIGS. 1 to 14. The integrated modeling method can provide an authoring environment in which 3D and 2D authoring environments of complicated ID used for a paper technical manual (TM) or an Interactive Electronic Technical Manual (IETM) are simplified by integrating 3D and 2D ID authoring environments of the complicated ID used for the paper TM and the IETM, provide a process model capable of implementing optimized integrated authoring environments by integrating Logistics Support Analysis (LSA) and the paper TM/IETM authoring, and significantly reduce time and labor required to author the ID of the paper TM and the IETM by automatically revising or modifying the ID where revision is requested by using CAD Log database information when contents of the LSA and the paper TM/IETM are revised and therefore the ID being used needs to be revised.

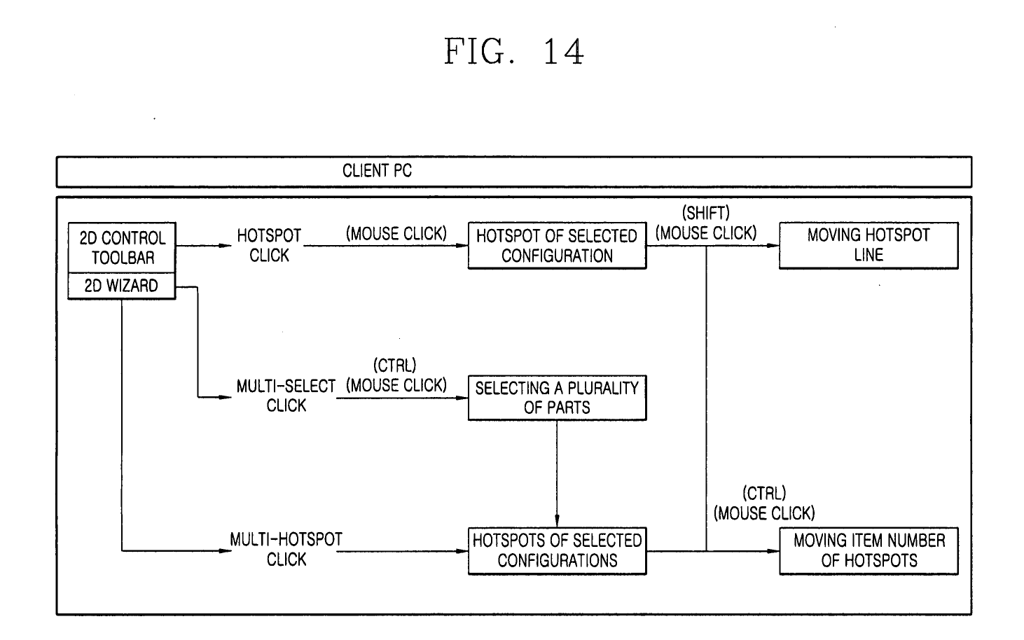

The integrated modeling method for ID authoring/modification using a 3D model database and a CAD Log database in accordance with the present invention comprises a first step of performing a 3D Model Import process by using 3D model data and logistics support data, converting a corresponding file into a 3D VRML model file which can be processed in an integrated ID environment, generating meta data from the converted 3D VRML model file and then saving the generated meta data in the 3D model database; a second step of importing a 3D model on the basis of a request list in which ID authoring is requested in a TM authoring system; a third step of adjusting movement, conversion and angle of the 3D model in order to set up a viewing point on the basis of the 3D model if a new model file exists by checking a Log of model files in the second step, and automatically exploding the parts of the 3D model by optimally adjusting intervals between parts of the 3D model and automatically exploding the parts of the 3D model in order to efficiently author ID of Illustrated Part Breakdown and an exploded view; a fourth step of collectively modifying and revising 3D and 2D ID by checking existing 3D and 2D modification Log and CAD-Log database in accordance with a CAD-Log modification procedure if the existing model file exists by checking the Log of the model files; and a fifth step of performing a 3D/2D data Save/Return process if 2D authoring ID work is completed by performing processes of 2D ID Line Retouch/Edit, 2D ID Group Setup, 2D ID Center Line Setup and 2D ID Hotspot Setup, allowing the ID to be used in all TMs by transmitting acquired paper TM and IETM to the paper TM and IETM database, and saving information on the revised ID in an ID management system and the CAD Log database. The integrated modeling processing procedure of the present invention which comprises the above-described steps will be described in detail with reference to FIGS. 1 and 14.

In the integrated ID authoring environment shown in FIG. 1, after information on parts and logistics support data basically necessary for ID authoring is inputted from the LSA system and the TM management system and a 3D model file is inputted from a product 3D model database 1 and a CAD system. An ID management system 5 generates an integrated database for the information necessary for ID management and authoring based on the information and the 3D model file.

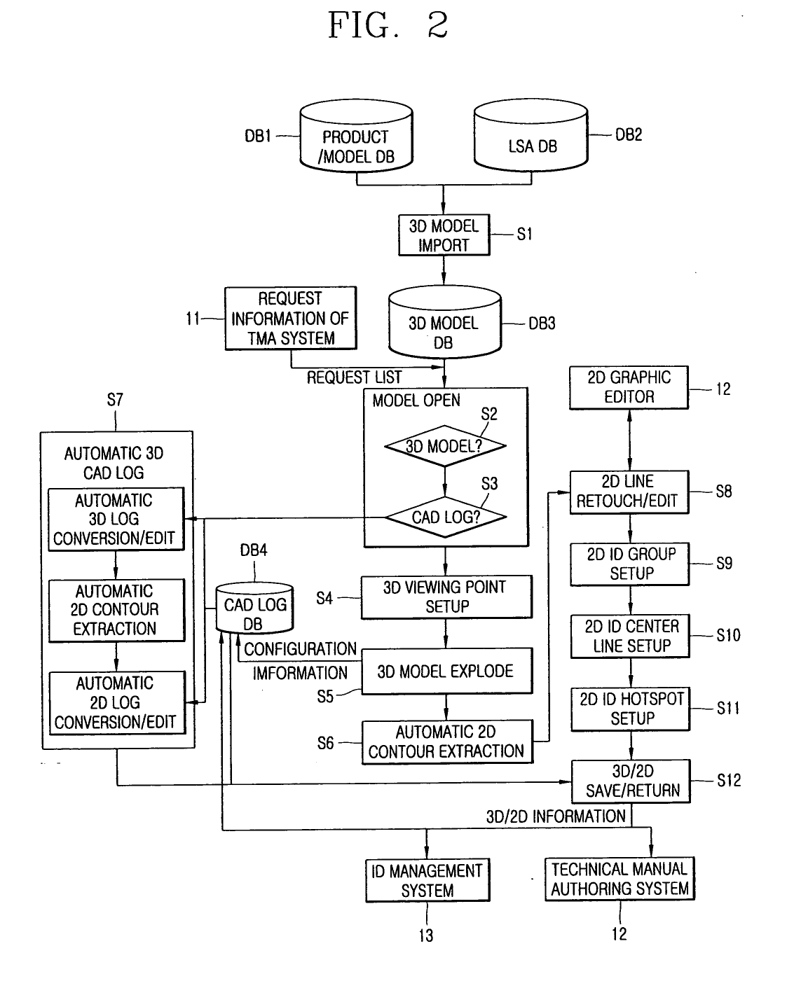

In addition, when a TM authoring system 7 requests ID necessary for the paper TM and the IETM by using a request list, an ID authoring system (5E) performs 3D and 2D ID authoring works by using the integrated and automated process model as shown in FIG. 2.

Thereafter, the completed ID is transmitted to the TM authoring system 7, the TM authoring system 7 finally provides integrated environments capable of generating the paper TM and the IETM by integrating the ID and contents of the TM.

Processes of performing a general procedure on the integrated ID authoring and modifying process model by using a LSA database, 3D model and CAD Log database under the integrated ID authoring environment will be described with reference to FIG. 2.

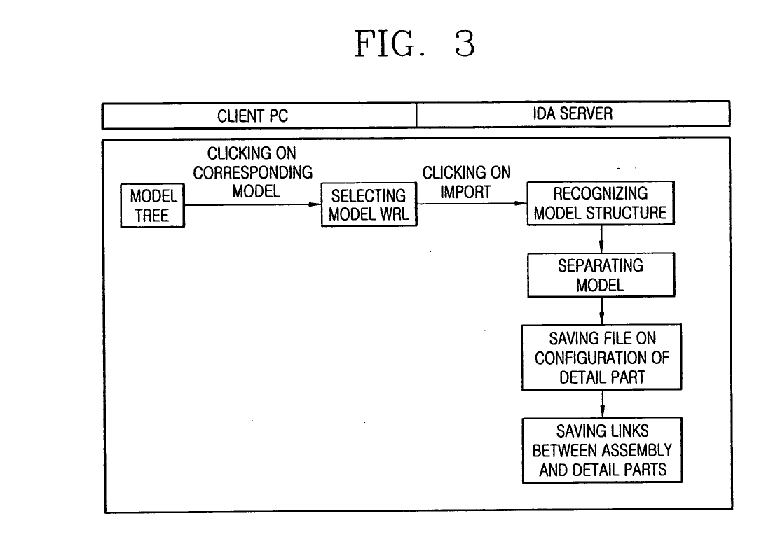

A corresponding file is converted into a 3D VRML model file which can be processed in the integrated ID environment by performing a 3D Model Import step (S1) as shown in FIG. 3 by using each 3D model data generated in the CAD system (e.g., CATIAor IDEAs) and saved in a product and model database (DB1) and logistics support data saved in an LSA database (DB2), meta data is generated from the 3D VRML model, and then the meta data is saved in a 3D model database (DB3) and managed.

That is, as shown in FIG. 3, when a user clicks on a corresponding model in a model tree in a client PC and selects a model WRL (a file format saved by a 3D VRML (Virtual Reality Modeling Language) file using a 3D model) file, a model structure is recognized and the model is separated in an IDA server, and then a file on a configuration of a detail part in the model and information on links between an assembly and detail parts are saved.

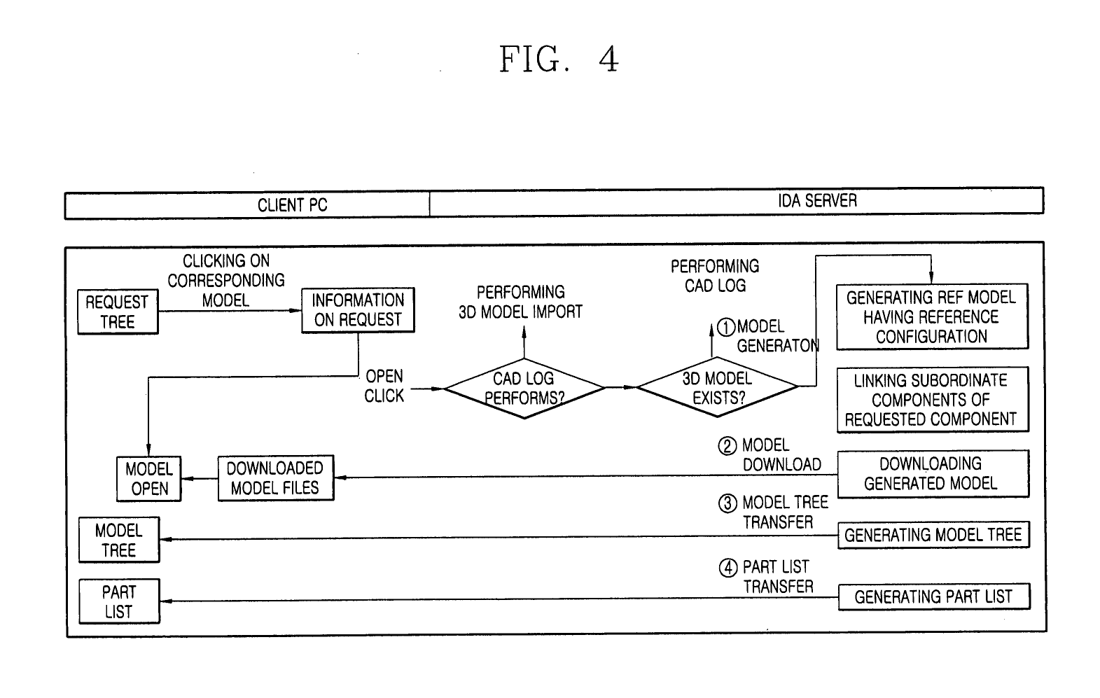

In a Model Open process (S2 and S3), a 3D model is imported on the basis of the request list in which the ID authoring is requested in the TM authoring system. The Model Open process is illustrated in detail in FIG. 4.

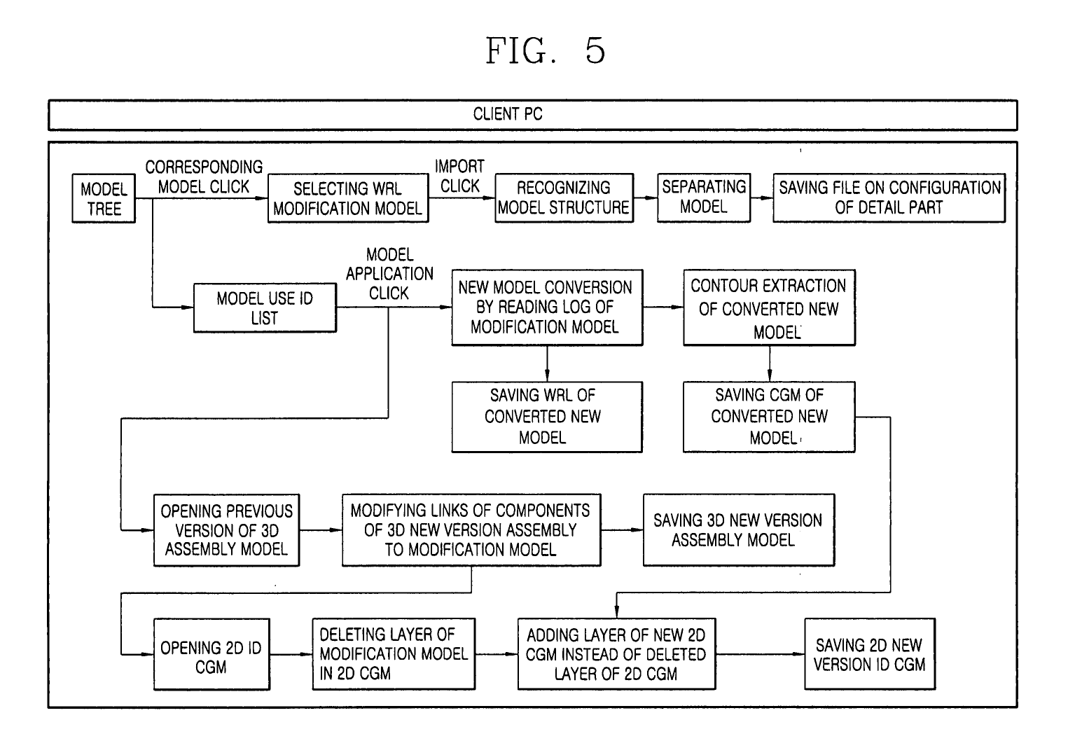

First, if a model exists in the 3D model database (DB3), it is imported. If it does not exist, the 3D Model Import process is performed. In addition, a 3D Viewing Point Setup step (S4) is performed if a new model file exists by checking the Log of the model files. If the existing model exists, an Automatic 3/2D CAD Log step (S7) as shown in FIG. 5 is performed, wherein 3D and 2D ID modification and revision are collectively carried out by checking the existing 3D and 2D modification Log and CAD-Log database in accordance with the CAD-Log modification procedure.

That is, as shown in FIG. 5, if the user clicks on a new model, that is, on a model desired to be modified into a modification model in the model tree, the above-described procedure is performed. In other words, when the user clicks on a corresponding model (old model) desired to be modified in the model tree, a file of a configuration of a component of a modification model (new model) which is generated by separating a configuration of the modification model (new model), into which the corresponding model (old model) is modified, is saved. Next, after the corresponding model (old model) is clicked, when the user selects in a model use ID list, the modification model (new model) of the corresponding model (old model) which is applied, the Log of the modification model (new model) is revised and the modification model is converted into a new model. A 3D VRML file (the 3D VRML file has a WRL extension) with respect to the converted new model is saved. Then, the contour of the converted new model is extracted and CGM (Computer graphics metafile) of the converted new model is saved. In addition, when the modification model (new model) of the corresponding model (old model) which is applied is selected in the model use ID list, a previous version of a 3D assembly model is opened in the model use ID list. And, after a part of a new version of the 3D assembly of the previous version of the 3D assembly model is linked to the modification model, the linked new version of the 3D version assembly model is saved. In addition, if a previous version of 2D ID CGM is opened by the user, a lower layer of the modification model in the previous version of the 2D CGM is deleted, a lower layer of the new version of the 2D ID CGM is added instead of the deleted lower layer, and the added new version of 2D version of ID CGM of is saved.

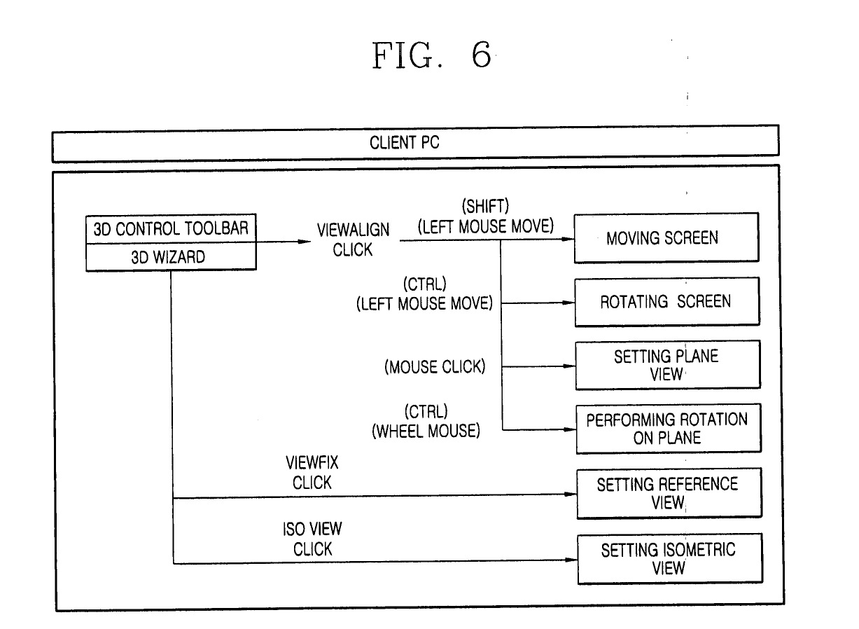

The 3D Viewing Point Setup step (S4) (refer to FIG. 6) is a step for adjusting movement, conversion and angle of a 3D model in order to provide the optimum ID understanding from a user's point of view on the basis of the 3D model.

That is, as shown in FIG. 6, in a state that a 3D control toolbar function is displayed, according to the user's key (e.g., a mouse key) operation, the screen is moved or rotated, or a front view is set or rotation on plane is made. In addition, in a state that a 3D wizard program is driven, a reference view is set or an Isometric view is set according to the user's key operation.

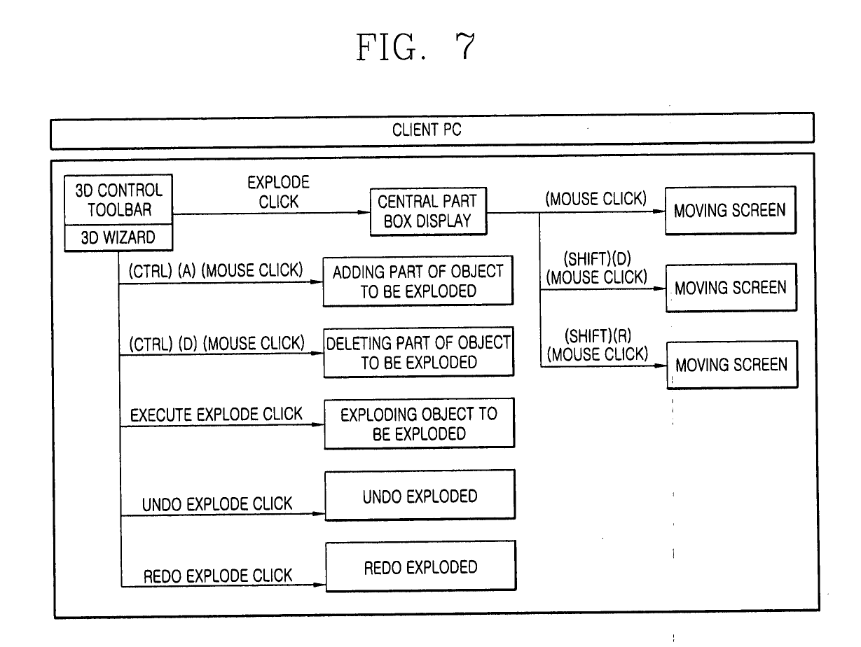

A 3D Model Explode step (S5) (refer to FIG. 7) is a step for automatically exploding parts of the 3D model by optimally adjusting intervals between the parts of the 3D model in order to efficiently author the supply ID and the exploded view. Here, the completed 3D model is saved in a CAD Log database (DB4).

That is, as shown in FIG. 7, in a state that the 3D control toolbar function is displayed, ‘Explode’ is clicked by the user, the central part is marked by a box. According to the user's key operation, the central part or an explosion direction is modified or the central part is rotated according to the explosion direction. In addition, in a state that the 3D wizard program is driven, a part of an object to be exploded is added/deleted or Undo/Redo explode is performed according to the user's key operation.

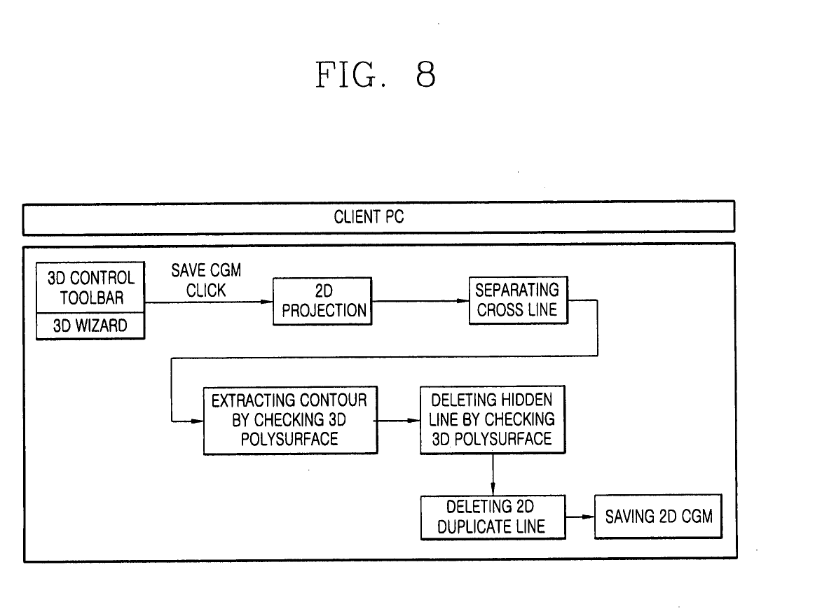

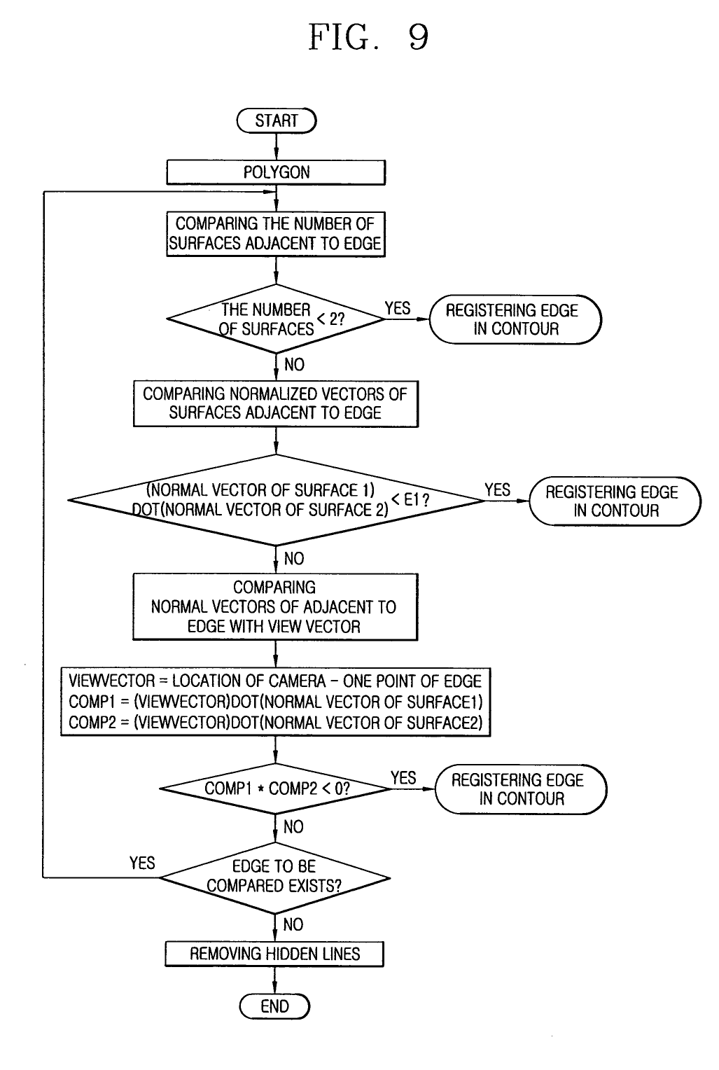

The automatic 2D Contour Extraction step (Refer to FIG. 8) in the automatic 3D/2D CAD Log step (S7) is performed by a contour extraction algorithm in which a 2D contour can be automatically generated by the 2D ID on the basis of 3D model configuration information. One part is made up of a plurality of polygons in the 3D model. When the entire product is made by assembling the plurality of parts, the contour with respect to each part is extracted by comparing each Edges of the polygon. The contour necessary for the ID is extracted by removing a hidden line by cross-checking between the extracted contours. FIG. 9 is a flowchart roughly illustrating the above-described contour extraction procedure.

That is, as shown in FIG. 9, if the number of surfaces adjacent to an edge is compared and the number of surfaces is less than 2, the edge is registered with the 2D contour. In addition, if the number of surfaces is equal to or more than 2, normalized vectors of surfaces adjacent to the edge are compared. If “(normalized vector of surface 1) dot (normalized vector of surface 2)” is less than E1, the edge is registered with the 2D contour. And, if “(normalized vector of surface 1) dot (normalized vector of surface 2)” exceeds E1, normalized vectors of the surfaces adjacent to the edge and a View Vector are compared. If a value obtained by multiplying two comparison values (Comp1 and Comp2) is less than ‘0’, the edge is registered with the 2D contour. Here, the comparison value Comp1 is a value of View Vector dot (normal vector of surface 1) and the comparison value Comp2 is a value of View Vector dot (normal vector of surface 2).

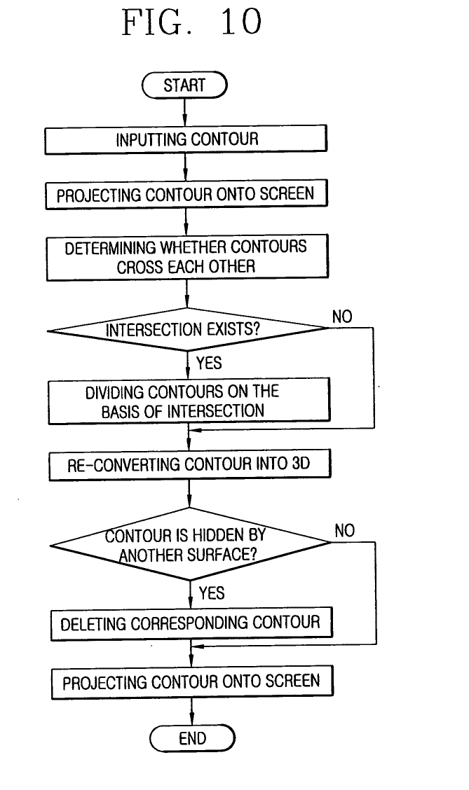

In addition, if the contour extraction process with respect to one part is completed, hidden lines covered by the part are removed and the final contour is obtained in order to improve the 2D ID in quality. FIG. 10 illustrates a Hidden Line removal process.

That is, as shown in FIG. 10, it is determined by projecting the contour onto the screen whether the contours cross each other or not. As a result of it, if it is determined that an intersection exists, the dividing of the contours is performed on the basis of the intersection and the contour is re-converted into 3D. And, if it is determined that the contour is hidden by another surface, the corresponding contour is deleted and then the contour is projected onto the screen.

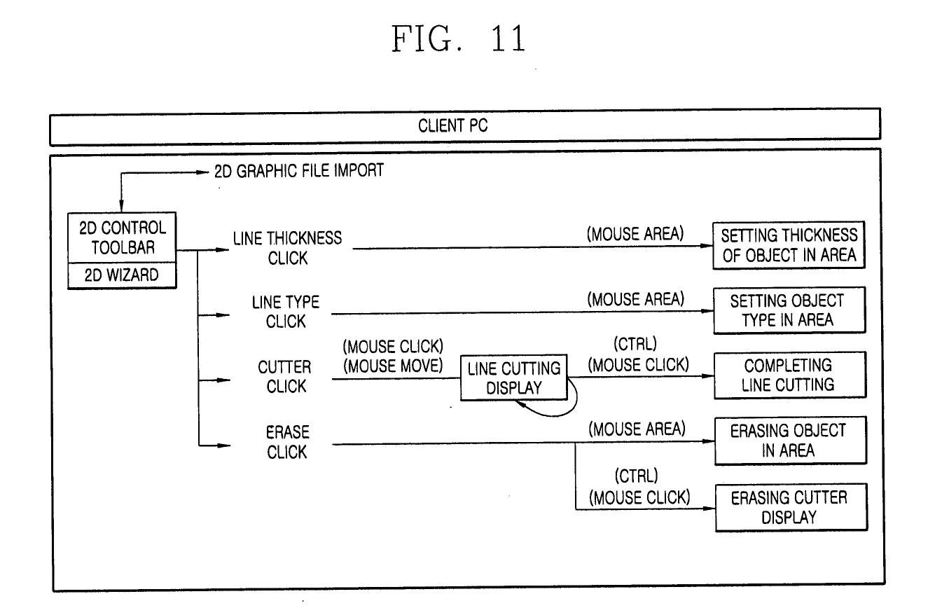

In a 2D ID Line Retouch/Edit step (S8) (Refer to FIG. 11), the 2D ID in which the contour is extracted is automatically imported to the 2D authoring environment, and the imported 2D ID and the previously authored 2D ID where a 3D model does not exist are merged, whereby final 2D ID is authored. In addition, unnecessary lines from the automatically extracted contour and the final revision work is performed.

That is, as shown in FIG. 11, in a state that the 2D control toolbar function is displayed and the 2D wizard program is driven, object thickness/type in an area is set, or a line is cut, or object/cutter mark in the area is erased according to the user's key operation.

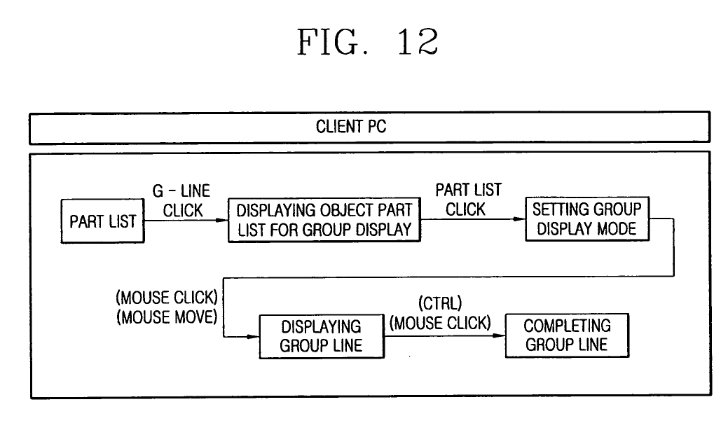

In a 2D ID Group Setup step (S9) (refer to FIG. 12), a group area is set with respect to IDs requiring for group display in accordance with the ID authoring standard.

That is, as shown in FIG. 12, when the user clicks on a group designation line in a Part List, an object part list for group display is displayed. If the user clicks on the Part list, a group display mode is set. Subsequently, a group line is displayed according to the user's key operation and group line display operation is completed according to the user's operation of a control key.

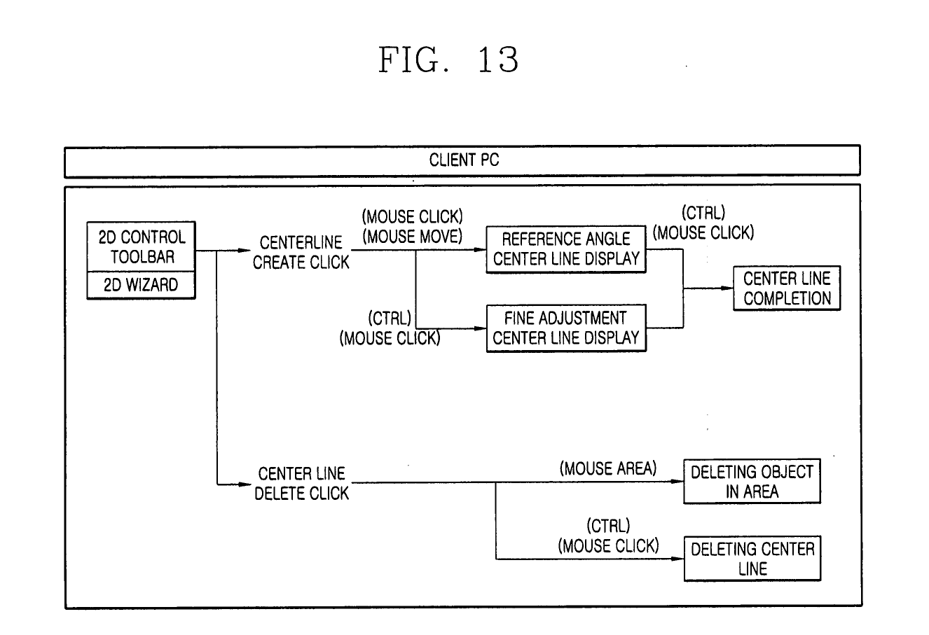

In a 2D ID Center Line Setup step (S10) (refer to FIG. 13), processes of displaying the center line is performed in accordance to the ID authoring standard.

That is, as shown in FIG. 13, in a state that the 2D control toolbar function is displayed and the 2D wizard program is driven, the center line can be drawn by displaying reference angle/fine adjustment center lines. In addition, the erasing of center line is requested by the user, the object in the area is erased or the center line is erased.

In a 2D ID Hotspot Setup step (S11) (refer to FIG. 14), processes of authoring a Hotspot area including a part indicating line for discrimination of part objects of the ID and link information capable of efficiently searching for parts in the IETM are performed.

That is, as shown in FIG. 14, in a state that the 2D control toolbar function is displayed and the 2D wizard program is driven, the Hotspot of the selected configuration is displayed, and a Hotspot Line is moved or Hotspot item number is moved according to the user's key operation.

When all 2D ID authoring works are completed by such processing procedures, a 3D/2D information Save/Return step (S12) is performed. Newly generated ID is generated into two IDs for the paper TM and the IETM in the ID authoring system. In addition, revised ID information is saved in the ID management system and the CAD Log database (DB4).

As so far described, the integrated modeling system and a method thereof for ID authoring/modification in accordance with the present invention can provide an authoring environment in which 3D and 2D authoring environments of complicated ID used for a paper technical manual (TM) or an Interactive Electronic Technical Manual (IETM) are simplified by integrating 3D and 2D ID authoring environments of complicated ID used for the paper TM and the IETM, provide a process model capable of implementing optimized integrated authoring environments by integrating Logistics Support Analysis (LSA) and the paper TM/IETM authoring, and significantly reduce time and labor required to author the ID of the paper TM and the IETM by automatically revising or modifying the ID where revision is requested by using CAD Log database information when contents of the LSA and the paper TM/IETM are revised and therefore the ID being used needs to be revised.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An integrated modeling method for Illustrated Drawing (ID) authoring/modification using 3D model and Computer-Aided Design (CAD) Log database, comprising:
a first step of performing a 3D Model Import process on the basis of 3D model data and logistics support data saved in each database, converting the imported 3D model file into a file which can be processed in an integrated ID environment, generating meta data from the converted file and then saving the generated meta data;
a second step of importing 3D models on the basis of a request list in which Illustrated Drawing authoring is requested in a Technical Manual (TM) authoring system;
a third step of adjusting movement, conversion and angle of the 3D model corresponding to a new model file in order to set up a viewing point on the basis of the 3D model if the new model file exists among the 3D models in the second step, and optimally adjusting intervals between parts of the 3D model corresponding to the new model file and automatically exploding the parts of the 3D model corresponding to the new model file in order to efficiently author Illustrated Drawing of Illustrated Part Breakdown and an exploded view;
a fourth step of collectively modifying and revising 3D and 2D ID by checking 3D and 2D modification Log and CAD-Log database corresponding to the existing model file in accordance with a CAD-Log modification procedure if the existing model file exists among the 3D model files in the second step;
and a fifth step of performing a 3D/2D data Save/Return process if 2D authoring ID work is completed by performing processes of 2D ID Line Retouch/Edit, 2D ID Group Setup, 2D ID Center Line Setup and 2D ID Hotspot Setup and allowing the ID to be used in all Technical manuals by transmitting acquired paper Technical Manual and Interactive Electronic Technical Manual (IETM) to the paper TM and IETM database.

2. The method of claim 1, wherein the imported 3D model file is converted into a 3D VRML model file which can be processed in the integrated ID environment.

3. The method of claim 1, wherein the 3D model data in the step 1 is outputted from an Logistics Support Analysis (LSA) database, and the logistics support data is outputted from a CAD Log database.

4. The method of claim 1, wherein the 3D Model Import process comprises:
a step in which a user selects a model WRL file in a model tree in a client PC; and
a step in which an IDA (Illustrated Drawing Authoring System) server saves a file on a configuration of a detail part in a model and information on links between an assembly and detail parts after recognizing a model structure and separating the model.

5. The method of claim of claim 1, wherein the second step comprises:
importing a model if the model exists in the 3D model database or performing the 3D Model Import process if the model does not exist; and
performing modification and revision of the 3D and 2D ID collectively by checking the existing 3D and 2D modification Log and CAD-Log database in accordance with a CAD-Log modification procedure if the existing model exists.

6. The method of claim 1, wherein the viewing point in the third step is set by the steps of:
moving or rotating a screen, or setting a front view or making rotation on plane according to the user's key operation in a state that a 3D toolbar function is displayed; and
setting a reference view or an isometric view according to the user's key operation in a state that a 3D wizard program is driven.

7. The method of claim 1, wherein a processing of authoring a supply ID and an exploded view in the third step comprises:
marking a central part by a box if the user clicks on ‘Explode’, modifying the central part or an explosion direction, or rotating the central part according to the explosion direction according to the user's key operation in a state that the 3D control toolbar function is displayed; and
adding/deleting a part of an object to be exploded or performing Undo/Redo explode according to the user's key operation in a state that the 3D wizard program is driven.

8. The method of claim 1, wherein the fourth step comprises:
extracting the contour with respect to each part by comparing each of Edges of the polygon when the entire product is made by assembling a plurality of parts; and
extracting the contour necessary for the ID by removing hidden lines by cross-checking between the extracted contours.

9. The method of claim 1, wherein the fourth step comprises:
performing the dividing of the contours on the basis of an intersection if the intersection is detected by determining whether or not the contours cross each other by projecting the contours onto the screen, and re-converting the contours into 3D; and
deleting a hidden line by deleting a corresponding contour if the contour is hidden by another surface and then projecting the contour onto the screen.

10. The method of claim 1, wherein the 2D ID Line Retouch/Edit process comprises:
setting object thickness/type in an area or cutting line or erasing object/cutting mark in the area according to the user's operation in a state that a 2D control toolbar function is displayed and a 2D wizard program is driven.

11. The method of claim 1, wherein 2D ID Center Line Setup in the fifth step comprises:
displaying an object part list for group display when a group designation line is clicked in a Part List and setting a group display mode according to the user's key operation; and
displaying a group line according to the user's key operation.

12. The method of claim 1, wherein the 2D ID Group Setup process in the fifth step comprises:
allowing to draw the center line by displaying reference angle/fine adjustment center lines in a state that the 2D control toolbar function is displayed and the 2D wizard program is driven; and
erasing the object in the area or deleting the center line if the erasing of center line is requested by the user.

13. The method of claim 1, wherein the 2D ID Hotspot Setup process in the fifth step comprises:
displaying a Hotspot of the selected configuration and moving a Hotspot line according to the user's key operation in a state that the 2D control toolbar function is displayed and the 2D wizard program is driven; and
display Hotspots of configurations of selected parts if the plurality of parts are selected by the user, moving the Hotspot lines or moving Hotspot item numbers according to the user's key operation.
